(19) United States
(12) Patent Application Publication
(10) Pub. No.: US 2005/0065310 A1
(43) Pub. Date: Mar. 24, 2005

(54) Urethane (meth)acrylate resin with acrylic backbone and ink compositions containing the same

(76) Inventors: Zhikai Jeffrey Wang, Smyrna, GA (US); Rosalyn M. Waldo, Smyrna, GA (US); Sue Ellen Williamson, Smyrna, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/667,367

(22) Filed: Sep. 23, 2003

(51) Int. Cl. C08G 18/00

(52) U.S. Cl. 528/44

(57) ABSTRACT

An acrylic urethane (meth)acrylate oligomer is provided, which has an acrylic urethane backbone comprising a reaction product of an acrylic polyol and a diisocyanate, which backbone is capped with a hydroxy(meth)acrylate. The acrylic urethane (meth)acrylate oligomer has residues in the following order: hydroxy(meth)acrylate−(diisocyanate−acrylic polyol)ₙ−diisocyanate−hydroxy(meth)acrylate where n is 1 to 10. The oligomer is useful in ink compositions.

### BACKGROUND OF THE INVENTION

1. Field of the Invention

The present invention relates generally to compositions containing urethane (meth)acrylate with an acrylic backbone for graphics applications and to methods for making these urethane (meth)acrylate with an acrylic backbone for application as ink resins. More particularly, the invention relates to a process for making these resin compositions which exhibit improved performance characteristics for use as printing inks or laminating inks, and to printing inks and laminating inks which incorporate such energy curable compositions.

2. Description of Related Art

Printing Inks

Printing inks generally are composed of coloring matter such as pigment or dye dispersed or dissolved in a vehicle. The ink can be a fluid or paste that can be printed onto a variety of substrates such as paper, plastic, metal, or ceramic and then dried or cured.

The most common printing processes are lithography, gravure, flexography, screen printing, and letterpress.

Required properties for an ink are very dependent on substrate and printing process, however all inks must have the following properties:
Printability
Rheology
Color development
Adhesion to substrate

Printability includes performance criteria including requirements related to the printing process, such as suitable consistency and tack for sharp, clean images, good ink distribution and transfer, good water balance with minimal piling and scumming, proper drying characteristics, and requirements related to the printed image, such as print uniformity and density, gloss, chemical resistance, and durability.

Rheology includes physical properties of the formulated ink which impact the printing process, including appropriate viscosity, suitable length to avoid fly or mist, and consistent viscosity at shear rates required to achieve line speed required for modern printing.

Laminating Inks

An important printing process for printing on flexible substrates is lamination printing. Lamination printing usually entails applying ink to the reverse side of the flexible substrate. The inked substrate is then laminated onto a second substrate. This lamination may be performed using either a molten film such as polyethylene, known as extrusion lamination, or by applying an adhesive and a second flexible substrate, a process known as adhesive lamination. The laminating inks must have excellent adhesion to the printing substrate as well as good adhesion (lamination strength) to the film to be laminated.

Required properties for a laminating ink are determined by substrate and printing process used, however a good adhesive laminating ink requires the following properties:
good print quality and good printing characteristics
good adhesion to multiple substrates
good compatibility with adhesives
good bond strength
flexibility

It has been discovered that the products of the present invention, when incorporated into pigmented compositions, offer advantages when used in lamination processes. Laminating inks incorporating the urethane (meth)acrylate with an acrylic backbone of the present invention give high performance in such applications due to increased bond and adhesion strength, and good compatibility with conventional and energy curable adhesives.

Printing on Plastics

A typical problem faced by conventional (water and solvent-borne) inks on non-absorbent substrates such as plastic films is blocking. On absorbent substrate, such as paper or cloth, the ink penetrates the substrate and thus “grabs” the surface, resulting in a “dry” printed product. However, on non-absorbent surfaces such as plastic film, if the ink is not allowed sufficient time to “dry”, the ink will block (stick or transfer to adjacent sheets in a roll or stack). Energy cure using actinic or ionizing irradiation promotes “instantaneous” cure of inks applied to plastic substrate, allowing the coated substrate to be rolled or stacked shortly after printing without blocking.

A problem for many conventional and energy curable inks is poor adhesion to plastic substrates. It is desirable to be able to print on a wide variety of substrates, e.g. plastic films such as cellulose acetate, polyethylene, polyethylene terephthalate, polyesters, polystyrene, rigid and flexible vinyl, polystyrene, cellophane; glassine, tissue, aluminum foils, liners, bags, paper labels, box coverings, gift wrappings, etc. Adhesion of the ink to the substrate is a particularly difficult problem to resolve in the case of non-absorbent substrates, and is affected by chemical and physical bonds. Wetting between the surface of the substrate and the ink is also of paramount importance.

It is an object of this invention to make an energy curable ink which additionally has good adhesion to a wide range of plastic substrates, with better printability and blocking resistance than conventional inks.

Lithographic Inks

A number of printing processes exist in the art. Although the ink composition and method of the present invention can be used in many or all of these processes, it is particularly useful for lithography. The printing apparatus commonly used in a lithographic process includes a printing plate which is treated to provide an oleophilic (oil attracting) ink-accepting image area and a hydrophilic (water attracting) ink-repelling nonimage area. During the printing process, the printing plate is continuously wetted with water and ink. The water is selectively taken up by the hydrophilic areas and the ink by the oleophilic areas of the printing surface. The ink is continuously conveyed from an ink source by means of a series of rollers to the printing plate located in the printing press, usually on a plate cylinder. Image portions of the printing plate that accept ink transfer the ink to a blanket cylinder as a reverse image. A portion of the ink from the blanket cylinder is then transferred to form a correct image on the printing substrate.

In general, lithographic ink formulations comprise a variety of components or ingredients including a varnish or vehicle component, pigments, solvents or diluents and various additives. The pigments, solvents or diluents and additives provide the ink composition with certain desirable characteristics such as color, drying speed, tack, viscosity, etc. These may be considered optional, depending upon the particular characteristics desired. Pigments or coloring agents may include organic and inorganic pigments and dyes and other known colorants. Solvents or diluents are principally used to control viscosity, improve compatibility of other components, among others. Additives and other auxiliary components may include, for example, waxes, greases, plasticizers, stabilizers, drying agents, supplemental drying agents, thickeners, fillers, inhibitors and others known to the art.

U.S. Pat. Nos. 6,239,189 and 6,316,517, both of which are incorporated herein by reference, disclose the use of printing ink compositions consisting of acrylic radicals as photopolymerizable binders in ultraviolet curable inks and coatings. Other components of the ink composition disclosed in these patents include inert polymers and plasticizers, pigments and inorganic fillers, photoinitiators and various other conventional additives for inks.

Cure

The major technologies being practiced today by the bulk of the coatings, graphics and adhesive industries are solvent borne, water borne and zero volatile organic compounds (VOC). The main film forming process is either drying (evaporation of a solvent from polymer solution) or curing (two or more components reacting to form a thermosetting polymer). While the water borne systems are environmentally friendly from a waste and pollution standpoint, both solvent and water based systems are energy intensive, requiring drying ovens to remove the solvent or water. Recently, there has been a technological push to eliminate solvents and water, i.e., to develop waterless zero VOC systems. Energy curing technology meets this criteria. In an energy curable system, a relatively fluid formulation is instantly converted to a cross-linked polymer when exposed to energy from a visible or ultra-violet (UV) light source or an electron beam (EB). This technology reduces waste and requires less overall energy consumption, while it can improve production speeds and produce properties such as high gloss and excellent abrasion resistance. UV or EB curing can be accomplished by free radical, cationic, anionic, or charge transfer mechanisms.

Rheology

Ink distribution and transfer, misting, print sharpness and clarity, print uniformity and density, penetration, rub resistance, piling and scumming are all related to the rheological characteristics of the ink used. In a press, especially at high speeds, inks experience high shear, which can reduce viscosity so they lose their optimum consistency. Rheology is one of the most important properties of the ink which must be suited to the substrate and manner of application.

Ink mist (or misting) is the term popularly applied to airborne droplets of ink ejected from press distribution systems and other rotating rollers. The ink mist can contaminate the pressroom and printed material and in some instances potentially becomes a serious fire hazard as well as a health hazard due to employee exposure. Indeed, ink mist is one of the major factors limiting the speed of printing.

Misting increases with increasing press speed and lower ink viscosity. High press speeds result in lower effective ink viscosity: at high press speeds, the press temperature increases due to frictional factors, and as the ink is subjected to higher shear from the fast moving press, shear-thinning results.

Adjusting press operating variables, e.g. temperature, humidity, ink film thickness, roller settings, etc. achieves limited success in reducing misting, especially when ever faster line speeds are required. Furthermore, it is known that while additives known to the art have some effect on reducing ink misting, these various methods do not permit high speed printing without concomitant misting and without adversely affecting the rheological and lithographic properties of the ink since the quality of the final print depends greatly upon such rheological properties.

Surveys of literature and prevailing practice regarding the misting of printing inks exist in the prior art, e.g. “Misting of Printing Inks”, by Fetsko and Lavelle, American Ink Maker, March 1979, p. 47 et seq.; “Ink and Paper in the Printing Process”, by Voet, Interscience Publishers, N.Y. (1952) pp. 79-86; “Ink Troubleshooting Tips”, American Printer (1982) pp. 40-45; pp. 37 and 39; “The Problem Of Ink Fly” by Bryan, The Canmaker, (October 1988); U.S. Pat. Nos. 5,000,787 and 5,844,071, etc.

Method

In a method of coating a substrate using the composition disclosed herein, the composition, optionally containing a photoinitiator, is applied to the surface of a substrate and subsequently exposed to a radiation source until an adherent dry polymerized film is formed on the substrate.

Objectives of this Invention

An objective of the invention is to provide ink compositions that are energy curable (curable with actinic or ionizing radiation such as ultraviolet light or electron beam irradiation).

Another objective of the invention is to provide ink compositions with significantly improved printability: better water window; good print contrast, and high printed color density.

Another object of the invention is to provide ink compositions which reduce misting on high speed printing machines.

Another objective of the invention is to provide ink compositions that have good adhesion to various plastic substrates after cure.

Another objective of the invention is to provide ink compositions that have stronger bond and pull strength in laminating applications. The invented oligomer surpasses other commercially available urethane acrylates commonly used in laminating inks.

### SUMMARY OF THE INVENTION

The present invention relates to a new generation of ink compositions, particularly for applications in energy curable printing inks and laminating inks.

In the present invention, as the crucial component, a urethane (meth)acrylate with an acrylic backbone is synthesized. In the synthesis, the acrylic backbone of the invented oligomer may be intentionally extended by reaction of the hydroxy groups pendent to or terminating the backbone acrylic oligomer with a slight molar excess of diisocyanate relative to the acrylic hydroxy groups, and controlling stoichiometry; then, the isocyanate terminated acrylic oligomer is capped with hydroxy (meth) acrylate or other ethylenically unsaturated groups at the ends.

In the present invention, the composition of the inks may also include pigments, resins, diluents such as solvents or polymerizable monomers or oligomers, and various additives, as known to the art, including waxes, greases, plasticizers, stabilizers, photoinitiators and/or curing agents, thickeners, fillers, inhibitors, wetting agents, flow and leveling agents, adhesion promoters, and others.

The term resin is used in its broadest sense to include all natural and synthetic oligomers capable of functioning as a component in a printing or printing ink environment. A monomer is a polymerizable compound with a low molecular weight (e.g. <1000 g/mole). An oligomer is a polymerizable compound of intermediate molecular weight, higher than a monomer. Preferably, the molecular weight of an oligomer is comprised between about 250 and about 4,000 daltons. A monomer is generally a substantially monodisperse compound whereas an oligomer or a polymer is a polydisperse mixture of compounds. A polydisperse mixture of compounds prepared by a polymerization method is a polymer.

As used herein, the term “(meth)acrylate” denotes both “acrylate” and “methacrylate”, the term “(meth)acrylic” denotes both “acrylic” and “methacrylic”.

While the compositions described are particularly applicable to energy-curable inks, these compositions can be used in any coating material, with or without pigmentation, for printing or non-printing applications.

As one of the important components, the invented oligomer was incorporated with others to formulate printing ink vehicles. In comparison to other commercially existing ink vehicles, the new formulated ink vehicles show several advantages:
1. Significantly improved printability-wider and more stable water window, good print contrast, high printed color density.
2. Easy press-cleanup
3. Low misting
4. Stronger bond and pull strength in laminating application, the invented oligomer surpasses other commercially available urethane acrylates
5. Compatible with polyester acrylates (often components of ink vehicles), compatible with isopropanol (often component of fountain solution), this wider compatibility provides ink formulators greater formulating latitude.
6. Good adhesion to various plastic substrates
7. Improved pigment wetting

### DETAILED DESCRIPTION OF THE PREFERRED EMBODIMENT(S)

In the present invention, as the crucial component, a urethane (meth)acrylate with an acrylic backbone is synthesized. In the synthesis, the acrylic backbone of the invented oligomer may be intentionally extended by reaction of the hydroxy groups pendent to or terminating the backbone acrylic oligomer with a slight molar excess of diisocyanate relative to the acrylic hydroxy groups, and controlling stoichiometry; then, the isocyanate terminated acrylic urethane oligomer is capped with hydroxy (meth) acrylate or other ethylenically unsaturated groups at the ends.

The reaction product of an acrylic polyol and an isocyanate is an acrylic urethane. For example, the synthesis of an acrylic urethane by reaction of a representative acrylic polyol with a representative isocyanate compound (R—NCO) is shown below:

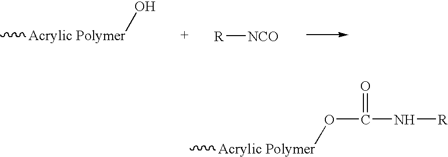

The resulting acrylic urethane will be terminated by isocyanate groups when a slight molar excess of isocyanate to hydroxy is used or by acrylic polymer polyols if there is a molar deficiency of isocyanate. If the acrylic polyol is difunctional in hydroxy, then the resulting acrylic urethane will have a linear structure. If the acrylic polyol hydroxy functionality is greater than two, then the acrylic urethane will be branched.

The structure of the acrylic urethane (meth)acrylate oligomer is preferably defined in terms of the reactants involved, i.e. hydroxy(meth)acrylate, diisocyanate and acrylic polyol compounds. These reactants undergo the following reactions:
(acrylic polyol+diisocyanate)+hydroxy(meth)acrylate
This gives a structure which contains reactant's residues in the following order:
hydroxy(meth)acrylate−(diisocyanate−acrylic polyol)ₙ−diisocyanate−hydroxy(meth)acrylate

This is called “structure 1” in the claims.

The urethane (meth)acrylate resin with acrylic backbone of this invention comprises an acrylic backbone. The acrylic backbone comprises a condensation reaction product of an acrylic polymer polyol and a diisocyanate, and which is preferably capped with a hydroxy(meth)acrylate.

Acrylic Polymer Polyol

The acrylic polymer polyol(s) used to make the urethane (meth)acrylate resin with acrylic backbone of the present invention typically are made from one or more polymerizable unsaturated compounds, and by several polymerization methods, as known to the art. One acrylic polymer polyol, or a combination of acrylic polymer polyols made by one or several methods may compromise the acrylic backbone of the resin of the present invention.

The acrylic polymer polyol is generally a viscous liquid. The viscosity measured at 25 degree C. is generally in the range of 100 to 1,000,000 centipoises (cps), preferably 1000 to 100,000 centipoises (cps).

With respect to the desired acrylic polymer polyol, the weight average molecular weight (Mw) measured by gel permeation chromatography (GPC) is generally in the range of 500 to 1,000,000, preferably 1000 to 300,000, while the number average molecular weight (Mn) is generally in the range of 500 to 1,000,000, preferably 1000 to 100,000, and more preferably 1000 to 5000. The dispersion index thereof (Mw/Mn) is generally in the range of 1.02 to 9.0, preferably 1.2 to 3.0.

The glass transition temperature (Tg) of the acrylic polymer polyol is typically less than 70 degrees C., preferably less than 30 degrees C., and more preferably less than 0 degree C. The Tg of the acrylic polymer polyol is also typically at least −70 degrees C., and preferably at least −50 degree C. The Tg of the acrylic polymer polyol can range between any combination of these values inclusive of the recited ranges.

The average number of hydroxy groups per polymer chain of the acrylic polymer polyol is generally in the range of 1.5 to 5.0, preferably from 1.7 to 3.0. Hydroxy groups may be introduced to the acrylic polymer by the incorporation of hydroxy functional polymerizable unsaturated compound(s) in the feed, by use of hydroxy functional initiator(s), by use of hydroxy functional chain-transfer agent(s), or by post-polymerization treatment of the acrylic polymer to product hydroxy groups by methods known to the art, such as hydrolysis of acetate groups, etc., or by combination of two or several methods.

A number of hydroxy functional polymerizable unsaturated compounds can be incorporated into the acrylic backbone directly to make acrylic polyols. These include hydroxy (meth)acrylates such as 2-hydroxyethyl acrylate (HEA) and methacrylate (HEMA); 2-hydroxypropyl (meth)acrylate, 3-hydroxypropyl (meth)acrylate, 2-hydroxybutyl (meth)acrylate; 4-hydroxybutyl (meth)acrylate, 3-hydroxypentyl (meth)acrylate, 6-hydroxynonyl (meth)acrylate; 2-hydroxy and 5-hydroxypentyl (meth)acrylate; 7-hydroxyheptyl (meth)acrylate and 5-hydroxydecyl (meth)acrylate. Additionally, the hydroxy alkyl (meth)acrylates may be alkoxylated to varying degrees. Examples include diethylene glycol mono(meth)acrylate, polyethylene glycol mono(meth)acrylate, propylene glycol mono(meth)acrylate, polypropylene glycol mono(meth)acrylate, and (meth)acrylates combining ethoxylation and propoxylation, such as are available from Laporte Performance Chemicals UK, LTD. Another class of suitable hydroxyalkyl acrylates includes lactone-hydroxyl acrylate adducts such as the caprolactone-2-hydroxyethyl acrylate adduct supplied by Dow/Union Carbide Corporation under the tradename TONE M-100. Mixtures of the above hydroxyalkyl acrylates may also be used. Additionally, the hydroxy functionality may be incorporated in the form of a hydroxy functional vinyl ether such as hydroxy butyl vinyl ether, hydroxy functional styrenic compounds, etc. Hydroxyl functionality may also be incorporated by using allyl alcohol and similar allylic monomers such as alkoxylated allyl alcohols which are hydroxy functional polymerizable unsaturated compounds which serve as both co-monomers and as radical chain transfer agents. Methods of incorporating these hydroxy functional allyl monomers into acrylic polyols is disclosed in U.S. Pat. Nos. 5,534,598, 5,919,874 and 6,153,716.

Hydroxy functional chain transfer agents include hydroxy functional 3-mercaptopropionate esters, 6-mercaptomethyl-2-methyl-2-octanol, 3-mercapto-1,2-propanediol, and 2-phenyl-1-mercapto-2-ethanol, and others as described in U.S. Pat. No. 4,593,081, and incorporated herein by reference. Additional mercapto-type chain transfer agents/initiators, such as 2-mercaptoethanol, are described in U.S. Pat. No. 6,489,412 and are also incorporated herein by reference. Such chain transfer agents allow for production of acrylic polymers having narrow molecular weight distributions in addition to reduced molecular weights.

Post polymerization treatment of the acrylic polymer to produce pendant hydroxy-functional group may be generated from a “precursor monomer” after the polymerization reaction which prepares the precursor polymer or oligomer. A precursor monomer is a monomer which has a group that may be converted to produce the desired functional group after the polymerization reaction is complete or substantially completed during the polymerization reaction. This requires the use of the precursor monomer in the polymerization and at least one additional conversion reaction to generate the desired functional group. An example of such a desired functional group monomer is vinyl alcohol which does not have a chemically stable monomeric form for use in polymerization reactions. Vinyl acetate may be used as the precursor monomer for vinyl alcohol. After the polymerization of the vinyl acetate with the primary monomers (or co-monomers), the precursor polymer is subjected to hydrolysis of the acetate group to generate the desired hydroxyl group. Further, the precursor monomer may be the same as the primary monomer used in the polymerization reaction. For example, vinyl acetate may be used as both the primary monomer and precursor monomer to prepare a precursor polymer. Partial hydrolysis of the vinyl acetate residues yields a polymer with residues of both vinyl acetate and vinyl alcohol.

The preferred acrylic polymer polyol is made from polymerizing or co-polymerizing flexible polymerizable unsaturated compounds such as acrylate and methacrylate monomers with flexible side groups, which yield homopolymers having low Tg's (glass transition temperatures), optionally with small amounts of other polymerizable unsaturated compounds, as known to the art. Preferably, 50 to 99.5 percent of the acrylic backbone should compromise flexible polymerizable unsaturated compounds which yield homopolymers with low Tg, and more preferably 80 to 95 percent. The flexible acrylic monomers typically have homopolymer Tg's in the range of −85 to 10 degrees C., and preferably, −70 to −10 degrees C.

Preferred low Tg flexible polymerizable unsaturated compounds include linear and branched acrylate and methacrylate monomers known to the art, as described in “The Polymer Handbook, 3^{rd} Ed.” (19889), Ed. by J. Brandrup and E. Imergut, John Wiley & Sons, pages IV-215-227 (and references therein), which is hereby incorporated by reference. These include, but are not limited to: ethyl acrylate, propyl acrylate, isopropyl acrylate, butyl acrylate, isobutyl acrylate, sec-butyl acrylate, pentyl (meth)acrylate, 2-ethyl butyl (meth)acrylate, hexyl (meth)acrylate, ethyl hexyl (meth)acrylate, octyl (meth)acrylate, nonyl (meth)acrylate, decyl (meth)acrylate, lauryl (meth)acrylate, alkoxyalkyl (meth)acrylates such as methoxyethyl (meth)acrylate, ethoxyethyl (meth)acrylate, propoxyethyl (meth)acrylate, butoxyethyl (meth)acrylate and ethoxypropyl (meth)acrylate, and combinations of two or several monomers. Other preferred polymerizable unsaturated compounds which yield homopolymers having low Tg's include fluorinated vinyl monomers such as fluorinated alkyl methacrylates and fluorinated alkyl acrylates; unsaturated compounds containing organosilicon groups; olefins and 1,3-dienes such as vinylcyclohexene, chloroprene, butadiene, isoprene, pentadiene, cyclobutadiene and methylbutadiene; and vinyl and allyl ethers.

Particular examples of other polymerizable unsaturated compounds which may be co-polymerized with the flexible polymerizable unsaturated compounds include, but are not limited to, (meth)acrylate monomers such as methyl (meth)acrylate, ethyl methacrylate, propyl methacrylate, isopropyl methacrylate, butyl methacrylate, isobutyl methacrylate, sec-butyl acrylate, tert-butyl (meth)acrylate, isoboranol (meth)acrylate, acrylic and methacrylic acid and salts thereof such as alkali metal acrylates and methacrylates; aryl esters of (meth)acrylic acid such as phenyl (meth)acrylate and benzyl (meth)acrylate; (meth)acrylic acid esters of alicyclic alcohol such as cyclohexyl (meth)acrylate; glycidyl (meth)acrylate, 2-ethylglycidyl ether (meth)acrylate, 4-butylglycidyl ether (meth)acrylate; acrylonitrile, methacrylonitrile and vinyl acetate; vinyl halide compounds such as vinylidene chloride, 2-chloroethyl acrylate and 2-chloroethyl methacrylate; 1-vinyl-2-pyrrolidinone; polymerizable compounds containing an oxazoline group such as 2-vinyl-2-oxazoline, 2-vinyl-5-methyl-2-oxazoline and 2-isopropenyl-2-oxazoline; vinyl monomers containing an amido group such as methacrylamide, N-methylolmethacrylamide, N-methoxyethylmethacrylamide and N-butoxymethacrylamide; styrenic compounds such as styrene, allylic derivatives of styrene, or vinylic derivatives of styrene; and other polymerizable unsaturated compounds, as known to the art.

Moreover, macromonomers (e.g., fluoromonomers, silicon containing monomers, or macromonomers of styrene, silicone, etc.) having a radical polymerizable vinyl group at one end can be mentioned as further examples of the polymerizable unsaturated compounds which may be co-polymerized into the acrylic polymer polyol.

These polymerizable unsaturated compounds can be used either individually or in combination.

Suitable methods for homo- and co-polymerizing ethylenically unsaturated monomers and/or other additional polymerizable monomers and pre-formed polymers are well known to those skilled in the art. The polymers may be prepared by bulk polymerization, solution polymerization, and emulsion polymerization using batch, semicontinuous, or continuous processes. The polymerization can be effected by means of a suitable initiator system, including free-radical initiators such as peroxides, hydroperoxides or azo-initiators; anionic initiation; and organometallic initiation. Molecular weight and polymer morphology can be controlled by choice of solvent or polymerization medium, concentration of initiator or monomer, temperature, pressure, staged addition of monomers and/or other reagents; and the use of chain transfer agents. Various polymerization methods are disclosed in Kirk-Othmer, Vol. 1 at pages 203-205, 259-297 and 305-307, which is hereby incorporated by reference. Additional details for preparation of suitable acrylic polymer polyols are disclosed in U.S. Pat. No. 4,158,736 (for anionic polymerization); U.S. Pat. No. 5,710,227 (high temperature radical polymerization); U.S. Pat. No. 5,362,826 (catalytic chain transfer polymerization); U.S. Pat. Nos. 5,324,879 and 6,489,412 (use of transition metal complexes); and in U.S. Pat. No. 6,153,713 (staged addition of monomers).

Isocyanate Compounds

The present invention utilizes aliphatic, cycloaliphatic, heterocyclic or aromatic polyisocyanates. It is preferred that diisocyanates be used, but isocyanate with functionality greater than 2 can also be used, preferably in an amount up to about 10 percent of the polyisocyanate. In the rest of description and claims, the generic term “polyisocyanate” is designated by “diisocyanate” for the sake of simplicity. Illustrative of difunctional isocyanates that can be used to prepare the polyurethane (meth)acrylates of this invention include, for example, 3-isocyanatomethyl-3,5,5-trimethylcyclohexylisocyanate (isophorone diisocyanate or IPDI), 2,4-toluene diisocyanate and 2,6-toluene diisocyanate as well as mixtures of these diisocyanates (TDI); 4,4′-diphenylmethane diisocyanate (MDI), 2,4′-diphenylmethane diisocyanate, 4,4′-dicyclohexyldiisocyanate or reduced MDI (also known as dicyclohexanemethane diisocyanate), meta- and para-tetramethyl xylene diisocyanate (TXMDI), hydrogenated meta-tetramethyl xylene diisocyanate [1,3-bis(isocyanatemethyl)cyclohexane], hexamethylene diisocyanate (HDI), norbornane diisocyanate (NBDI), 2,2,4- and 2,4,4-trimethylenehexamethylene diisocyanate (TMDI), 1,5-naphthylene diisocyanate (NDI), dianisidine diisocyanate, di(2-isocyanatoethyl)bicyclo[2.2.1]-hept-5-ene-2,3-dicarboxylate, 2,4-bromotoluene diisocyanate, 2,6-bromotoluene diisocyanate, 2,4-/2,6-bromotoluene diisocyanate, 4-bromo-meta-phenylene diisocyanate, 4,6-dibromo-meta-phenylene diisocyanate, and the like, including mixtures thereof. In addition, isocyanate functional biurets, allophonates, and isocyanurates of the previously listed isocyanates, as known to the art, may be used. 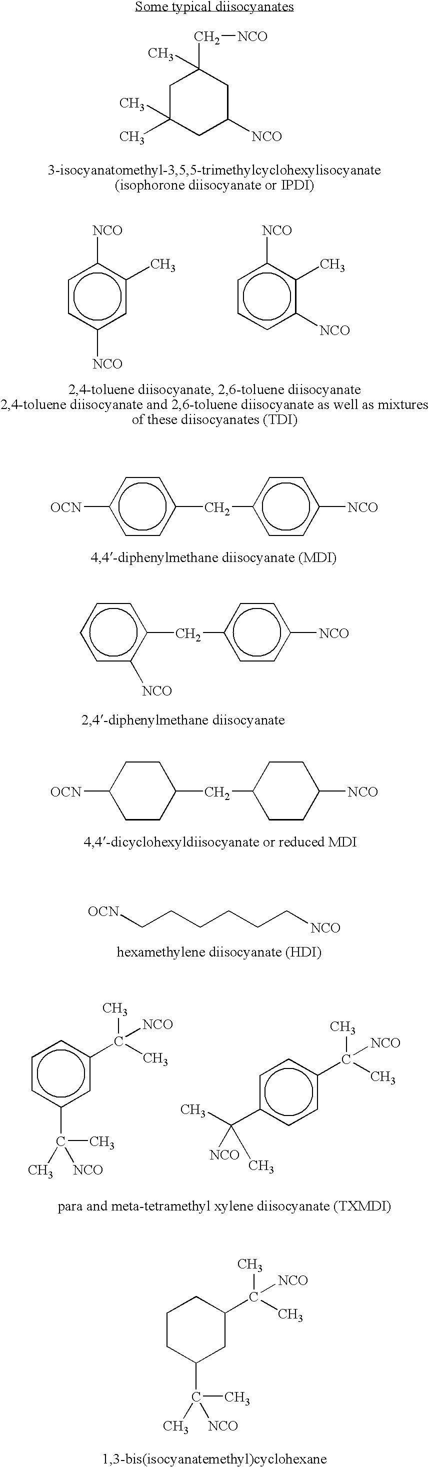 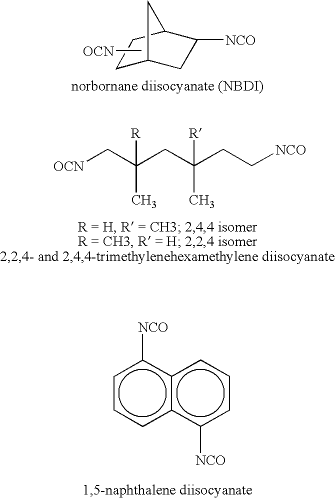
Catalyst for Isocyanate-Hydroxy Reactions

If desired, catalysts for the hydroxyl/isocyanate reactions to form urethane linkages may be used. Illustrative of such catalysts are the known urethane catalysts which can be used in conventional amounts and include the amines or organometallic compounds such as triethylamine, ethylene diamine tetraamine, morpholine, N-ethyl-morpholine, triethanolamine, piperazine, N,N,N′,N′-tetramethyl-butane-1,3-diamine, dibutyltin dilaurate, dibutyltin oxide, stannous octanoate, stannous laurate, isoctyltin diacetate, lead octanoate, zinc octanoate, zirconium chelate catalysts, and the like.

Process Conditions for Isocyanate-Hydroxy Reactions

The reactions typically are carried out in a solvent-free system, although inert solvents such as toluene, benzene, xylene, and other aromatic hydrocarbons, heptane, octane, nonane, and other aliphatic hydrocarbons, methyl ethyl ketone, methyl i-butyl ketone, methyl amyl ketone, 2-ethoxyethyl acetate, 2-ethyoxybutyl acetate, and the like may be used. Mixtures of such inert solvents may also be employed.

Solvent may be subsequently removed, if desired, by methods known to the art such as vacuum distillation, rotary evaporation, wiped film distillation, etc.

Reaction temperatures can vary from about 15 degree C. to about 105 degree C. or higher, preferably from about 30 degree C. to about 95 degree C. The reaction time will vary according to the size of the batch of product being produced, the nature of the isocyanate employed, the nature of the hydroxyalkyl (meth)acrylate used, solvent, and the reaction temperature. It is preferred that the isocyanate/acrylic polyol reaction be carried out in a dry nitrogen atmosphere and the resulting isocyanate terminated prepolymer/hydroxyalkyl (meth)acrylate reaction be carried out in an oxygen-containing atmosphere such as dry air and that a stabilizer be used in the latter step. Alternately, an adduct of the diisocyanate and hydroxyalkyl (meth)acrylate(s) may be made first using suitable stabilizers, followed by addition of the acrylic polyol. If using the latter process, or if all three ingredients are reacted at the same time, it is preferred that a dry air or other oxygen-containing atmosphere be used.

In-Process Stabilizers for Isocyanate-Hydroxy Reactions

Illustrative of the stabilizers or free-radical inhibitors that can be used alone or in combination to prevent polymerization of acrylate functionality during the reaction of hydroxyalkyl acrylates with isocyanate terminated prepolymers are hydroquinone, 4-methoxyphenol, hydroquinone monomethyl ether, phenothiazine, benzoquinone, methylene blue, 2,5-di-t-butylhydroquinone, and other free radical inhibitors known in the art. Usually the inhibitors are used at a concentration of about 10 parts per million to about 5000 parts per million, more preferably from about 50 parts per million to about 1500 parts per million.

Hydroxy (meth)acrylates

Examples of suitable hydroxy (meth)acrylates include hydroxy (meth)acrylates such as 2-hydroxyethyl acrylate (HEA) and methacrylate (HEMA); 2-hydroxypropyl (meth)acrylate, 3-hydroxypropyl (meth)acrylate, 2-hydroxybutyl (meth)acrylate; 4-hydroxybutyl (meth)acrylate, 3-hydroxypentyl (meth)acrylate, 6-hydroxynonyl (meth)acrylate, 2-hydroxy and 5-hydroxypentyl (meth)acrylate; 7-hydroxyheptyl (meth)acrylate and 5-hydroxydecyl (meth)acrylate. Additionally, the hydroxy alkyl (meth)acrylates may be alkoxylated to varying degrees: examples include diethylene glycol mono(meth)acrylate, polyethylene glycol mono(meth)acrylate, propylene glycol mono(meth)acrylate, polypropylene glycol mono(meth)acrylate, and (meth)acrylates combining ethoxylation and propoxylation, such as are available from Laporte Performance Chemicals UK, LTD. Another class of suitable hydroxyalkyl (meth)acrylates includes lactone-hydroxyl acrylate adducts such as the caprolactone-2-hydroxyethyl acrylate adduct supplied by Dow/Union Carbide Corporation under the tradename TONE M-100. Mixtures of the above hydroxyalkyl (meth)acrylates may also be used.

Other mono-hydroxyl functional ethylenically unsaturated monomer, as are known in the art, including hydroxy functional alkyl vinyl ethers such as 4-hydroxy butyl ether and hydroxy functional allylic compounds such as allyl alcohol may also be used in place of some or all of the these hydroxyalkyl (meth)acrylates.

Urethane Acrylates

Urethane acrylates are a reaction product of polyol and diisocyanate capped with hydroxy functional (meth)acrylate. They contain (meth)acrylate groups for subsequent reactions. Surface Specialties UCB makes and markets a number of Urethane Acrylates. Of these, EB 230 from Surface Specialties UCB (a high molecular weight aliphatic urethane acrylate characterized by low viscosity and good adhesion to plastic substrates) is used in some adhesive applications, and EB 4827 from Surface Specialties UCB (an aromatic urethane diacrylate designed for applications requiring good flexibility and adhesion) is used in some graphics (ink) applications. Almost all urethane (meth)acrylates on the market are made from difunctional or trifunctional polyether polyols or polyester polyols. A few urethane acrylates on the market are capped isocyanates (which do not contain polyols).

Urethane(meth)acrylates with Acrylic Backbones

The urethane (meth)acrylates with acrylic backbones of this invention are made by reacting diisocyanate(s), acrylic polyol(s), and hydroxy(meth)acrylate(s). These urethane (meth)acrylates with an acrylic backbone have free [reactive] (meth)acrylate or other ethylenically unsaturated functionality, attached to the acrylic “backbone” by urethane linkages. The acrylic groups in the backbone may be further extended by additional urethane linkages.

An example of the new oligomer (urethane (meth)acrylate with an acrylic backbone):
Hydroxy(meth)acrylate−diisocyanate−acrylic polyol−diisocyanate−hydroxy(meth)acrylate

An example when the acrylic backbone is extended by urethane linkages:
Hydroxy(meth)acrylate−(diisocyanate−acrylic polyol)ₙ−diisocyanate−hydroxy(meth)acrylate
where n is equal to 1 to 10, preferably 1 to 7.

Although the representative molecular structure of the urethane (meth)acrylate with an acrylic backbone is shown above as being linear, branching due to the inclusion of acrylic molecules containing more than two hydroxy groups per molecule is likely.

Also provided in this invention is an energy curable ink composition, which comprises the oligomer described herein.

Ink Compositions

The ink composition of this invention may be substantially water free and/or substantially solvent free, or may contain solvents or water, as needed to control viscosity. Preferably, up to 15 percent solvent may be added to the ink composition, more preferably less than 10 percent solvent, and most preferably less than 5 percent solvent. The preferred amount of water in the ink formulation is less than 20 percent, preferably less than 10 percent, and most preferably, less than 5 percent. The term “substantially water free” means a water content of less than 5% by weight of water. The term “substantially solvent free” means a solvent content of less than 5% by weight of solvent.

The ink composition of this invention may contain an amount of acrylated oligomers in the range from 5 to 95 percent, preferably 40 to 60 percent by weight based on total formula weight.

The ink formula may be pigmented with any of a variety of conventional organic or inorganic pigments, such as titanium dioxide, phthalocyanine blue, carbon black and chrome yellow. Suitable pigments include inorganic pigments such as titanium dioxide, zinc oxide, zinc sulfide, lithopone, lead oxides, iron oxide, bismuth vanadate, chromium(III) pigments, lead chromate, carbon black, and metal pigments; and organic pigments such as pigments listed in Table 1 on pages 42-45 of the “Kirk-Othmer Encyclopedia of Chemical Technology”, Volume 19, 4th Edition (1996), including Cyan Irgalite Blue GLO (Ciba Specialty Chemicals), Magenta Irgalite Rubine L4BD (Ciba Specialty Chemicals), Yellow Irgalite Yellow BAW (Ciba Specialty Chemicals) and Black Raven 450 (Columbian Chemicals Co.). Typical colorant amount ranges from 15-40 percent of the total formula weight. It is also suitable to use acrylated multifunctional monomers as components of the printing ink. These monomers are used to adjust viscosity, rheology and to assist pigment wetting. Monomer concentration can range from 5-30 percent, preferably 10-20 percent by weight.

Commonly known modifiers may also be used in formulae with the acrylated oligomers, monomers and the invention. These modifiers include wetting agents for the pigment, leveling agents and slip agents. Modifiers are commonly used at levels up to 3 percent of the formula weight, preferably about 1 percent. In order to achieve suitable viscosity and rheology, bodying agents are used. Typical bodying agents include magnesium silicate (talc), calcium carbonate, clay and silica. Bodying agents can be used up to 10 percent of the total weight, but usually range between 2-5 percent of the formula.

For inks curable by actinic radiation photoinitiators are used to produce free radicals or ionic species to initiate the polymerization process. Photocleavage and photoabstraction initiators can be used, at concentrations from 4-12 percent of the formula. A more typical range would be 8-10 percent.

The ink composition may further comprise at least one ingredient selected from the group consisting of diluents, waxes, greases, plasticizers, thickeners, fillers, inhibitors, flow agents, and adhesion promoters.

The ink composition may be energy curable with actinic or ionizing radiation.

Thermal Cure

Because of the presence of a plurality of unsaturated acrylate groups in their molecules, the compounds according to the present invention are readily polymerizable and can form three-dimensional cross-linked polymers under the following conditions: by the action of heat at a temperature between 50 degrees and 250 degrees C., preferably between 50 degrees and 150 degrees C., preferably in the absence of oxygen; by the addition of radical initiators which decompose at a higher temperature (for example above 40 degrees C.) if a suitable accelerator is added. Suitable radical initiators include peroxides, hydroperoxides, percarbonates, azo compounds or the like which decompose under the influence of heat to produce radicals capable of initiating polymerization.

Energy Cure

More typically, it is desirable to energy cure the compounds of the present invention by exposure to actinic or ionizing radiation.

Ionizing Radiation

Ionizing radiation is radiation of electromagnetic nature (gamma-rays or X-rays) or of corpuscular nature (accelerated electrons). Cure can be accomplished even in the presence of air and without initiator. Equipment capable of generating a curtain of electrons with energies between 50 and 300 KeV is particularly suitable for this purpose and its use is well documented in the literature. Examples of useful energy sources for ionizing radiation include X-Ray machines; electron accelerators such as van de Graaf machines, travelling wave linear accelerators, particularly of the type described in U.S. Pat. No. 2,736,609, and natural and synthetic radioactive material, for example cobalt 60, etc.

Actinic Radiation

Other useful energy sources for energy curing the compounds of the present invention includes ultraviolet or visible light (actinic radiation). Sources of radiant energy appropriate for initiating cure of the formulations have been described extensively in the literature and are well known to those skilled in the art. Particularly preferred sources of radiation emit electromagnetic radiation predominantly in the ultra-violet band, but any wavelength of visible and or ultra-violet light, provided that a photosensitizer or photoinitiator is added, may be used. Many commercial sources are available for production of non-particulate radiation, typically producing wavelengths generally less than 700 nanometers. Especially useful is actinic radiation in the 180-440 nm range which can be conveniently obtained by use of one of several commercially available ultra-violet sources specifically intended for this purpose. These include low, medium and high pressure mercury vapor lamps, He-Cd and Ar lasers, xenon arc lamps, etc.

Cure Dose

The amount of radiation necessary to cure the composition depends on the angle of exposure to the radiation, the thickness of the coating to be applied, and the amount of polymerizable groups in the coating composition, as well as the presence or absence of photoinitiator. For any given composition, experimentation to determine the amount of radiation sensitive pi bonds not cured following exposure to the radiation source is the best method of determining the amount and duration of the radiation required. Typically, an ultra-violet source with a wavelength between 200 and 420 nm (e.g. a filtered mercury arc lamp) is directed at coated surfaces carried on a conveyor system which provides a rate of passage past the ultra-violet source appropriate for the radiation absorption profile of the composition (which profile is influenced by the degree of cure desired, the thickness of the coating to be cured, and the rate of polymerization of the composition).

Photoinitiators

Photoinitiator systems having a corresponding sensitivity to actinic radiation are normally incorporated into formulations containing compounds of the present invention and upon irradiation lead to the formation of reactive species capable of initiating polymerization.

After the addition of 0.01 to 15 percent by weight of photoinitiators and/or photosensitizers, the products of the present invention or mixtures containing these products can be used for the production of transparent varnishes for coating a large variety of substrates. Typically, addition of 0.1 to 30 percent photoinitiator and/or photosensitizer is required to effect cure of pigmented coatings such as inks upon exposure to actinic radiation.

Useful photoinitiators and/or photosensitizers include compounds in the following categories: ketones and their derivatives, carbocyanines and methines, polycyclic aromatic hydrocarbons, such as anthracene or the like, and dyestuffs, such as xanthenes, safranines and acridines. More generally, these are essentially chemical substances belonging to one of the following major categories: compounds containing carbonyl groups, such as pentanedione, benzil, piperonal, benzoin and its halogenated derivatives, benzoin ethers, anthraquinone and its derivatives, p,p′-dimethylaminobenzophene, benzophenone and the like; compounds containing sulfur or selenium, such as the di- and polysulfides, xanthogenates, mercaptans, dithiocarbamates, thioketones, beta-napthoselenazolines; peroxides; compounds containing nitrogen, such as azonitriles, diazo compounds, diazides, acridine derivatives, phenazine, quinoxaline, quinazoline and oxime esters, for example 1-phenyl-1,2-propanedione 2-[0-(benzoyl)oxime]; halogenated compounds, such as halogenated ketones or aldehydes, methylaryl halides, sulfonyl halides or dihalides; and photoinitiator dyestuffs, such as diazonium salts, azoxybenzenes and derivatives, rhodamines, eosines, fluoresceines, acriflavine or the like. Common photoinitiators include 2,2-diethoxyacetophenone, dimethoxyphenylacetophenone, phenyl benzoin, benzophenone, substituted benzophenones, and the like. It is understood by those skilled in the art that when benzophenone and similar compounds are used as photoinitiators, a synergistic agent, such as a tertiary amine or polymeric amine such as a secondary or primary amine terminated poly(propylene oxide) polyol are employed to enhance the conversion of photo-adsorbed energy to polymerization-initiating free radicals.

The photoinitiators and/or photosensitizers supply to the molecules containing unsaturation or to the initiator part of the energy transmitted by the light. By means of the unsaturated system or systems or of a photoinitiator, the photosensitizers produce free radicals or ions which initiate the polymerization or the cross-linking of the composition. With regard to the photosensitizers or photoinitiators which can be used according to the present invention, the following references are in particular quoted: G. Delzenne, Ind. Chim. Belge, 24, 739-764/1959; J. Kosar, “Light Sensitive Systems”, pub. Wiley, New York, 1965; N.J. Turro, “Molecular Photochemistry”, pub. Benjamin Inc., New York, 1967; H. G. Heine et al., Angew. Chem. 84, 1032/1972.

Inhibitors

To ensure that the composition does not prematurely polymerize, free radical inhibitors and/or antioxidants may be added to the polymerizable composition. Examples of suitable inhibitors include hydroquinone and the methyl ether thereof or butylated hydroxy toluene at a level of from 5 ppm to 2000 ppm or more by weight of the polymerizable components. Additives which are particularly useful in prolonging the shelf-life of the composition can also be used, e.g. ultra-violet stabilizers such as Florstab UV-II from Kromachem. Additionally, antioxidants and stabilizers such as are described in Volume 3, pages 424-447 of “Kirk-Othmer Encyclopedia of Chemical Technology”, 4^{th} Ed., 1992, published by John Wiley & Sons, New York may be added.

Benefits of Inks of this Invention

Inks made with these oligomers exhibit good adhesion to plastic in addition to advantages such as good printability and low misting, thus can be used to make laminating inks. Laminating inks are printed on plastic substrate, then the printed material is covered with a transparent layer of plastic. (Cure can be before or after lamination.) The laminating ink must adhere to both the plastic substrate and to the plastic cover layer. Typical energy curable oligomers have poor adhesion to plastic, thus cannot be used in these applications. Other urethane acrylate oligomers, such as EB 230 from Surface Specialties UCB (a high molecular weight aliphatic urethane acrylate characterized by low viscosity and good adhesion to plastic substrates), exhibit good adhesion to plastics, but are not commonly used as ink resins because of very poor printability and poor pigment wetting, and high misting.

The ink compositions may be in any color, preferably the process colors of black, cyan, magenta or yellow. The inks have a low ink misting, preferably AE<6. Preferably, the inks also have a 90-100% adhesion to vinyl, polystyrene and polycarbonate.

Another embodiment of this invention is an article of manufacture, comprising a substrate having a surface coated with the energy curable ink composition, wherein the ink composition is a laminating ink composition.

A further embodiment of the invention is an article of manufacture, comprising a substrate having a surface coated with the energy curable ink composition, wherein the ink composition is a lithographic ink composition.

Another embodiment of the invention is an article of manufacture, comprising a substrate having a surface coated with the energy curable ink composition which has been subjected to energy curing.

Synthesis of the Urethane (meth)acrylate with an Acrylic Backbone of this Invention

The following examples are given for the purpose of illustrating the present invention. While the following description contains many specifics, these specifics should not be construed as limitations on the scope of the invention, but merely as exemplifications of preferred embodiments thereof. Those skilled in the art will envision many other possible variations that are within the scope and spirit of the invention as defined by the claims appended hereto.

### EXAMPLE 1

2,480.2 g of Actflow UT-1001 (Soken Chemical & Engineering, Co., LTD), an acrylic polyol based primarily on 2-ethyl hexyl acrylate, was mixed with 717.3 g of OTA-480 (Propoxylated Glycerol Triacrylate, Surface Specialties UCB), 3.6 g of Triphenyl Stibine (Atofina Chemicals), and 5.4 g of Dabco T-12 (Air Products and Chemicals), dibutyltin dilaurate, at room temperature. Then, 350.0 g of Desmodur I (Bayer), isophoronediisocyanate, was charged to 5 L a round-bottomed flask, and the polyol mixture was added, with agitation over 30 minutes. The temperature increased from 27 to 66° C. The contents of the flask were held at 66° C. for 30 minutes, then the temperature was increased to 88° C., and the contents were held at 88° C. for 1 hour. 55.7 g of 2-hydroxy ethyl acrylate (Dow), mixed with 0.7 g of hydroquinone (Eastman Chemicals) was added over 10 minutes. The flask contents were held at 88° C. for another hour, then an additional 0.7 g of hydroquinone was added with stirring. After stirring an additional 5 to 20 minutes, the product poured from the flask. The resulting product was a clear, water-white viscous liquid.

### EXAMPLE 2

514 g of Actflow UT-1001 (Soken), was mixed with 1.31 g of Dabco T-12 (Air Products and Chemicals), and heated to 93 C. 158.5 Desmodur I (Bayer) was charged to a 3 L round-bottomed flask, and the polyol mixture added over 30 minutes. The temperature increased from 20 to 60 C. The content of the flask were held at 70 C for 2 hrs and 15 minutes, then 71 g of 2-hydroxy ethyl acrylate (Dow), mixed with 0.18 g para-methoxy phenol (Aldrich) was added over 20 minutes. The flask contents were heated from 70 to 88 C. After an additional 85 minutes, another 4 g of 2-hydroxy ethyl acrylate was added. After heating an additional 30 minutes, the flask was covered and allowed to cool to room temperature. After 13 hours, it was re-heated to 93 C, and held at 85 to 93 C for 2 hours, after which an additional 0.18 g of para-methoxy phenol was added, with stirring. After stirring an additional 5 to 20 minutes, the product poured from the flask. The resulting product was a clear, water-white viscous liquid.

### EXAMPLE 3

541 g of Actflow UT-1001 (Soken), was mixed with 0.97 g of Dabco T-12 (Air Products and Chemicals), and heated to 93 C. 84 g of Desmodur I (Bayer) was charged to a 3 L round-bottomed flask, and the polyol mixture added over 85 minutes. During this time, the temperature increased from 20 to 70 C. The content of the flask were held at 70-90 C for 90 minutes, then 19.7 g of 2-hydroxy ethyl acrylate (Dow) and 0.13 g para-methoxy phenol (Aldrich) were added. The flask contents were held at 82-88 C. After an additional 2½ hours, an additional 0.13 g of para-methoxy phenol was added, with stirring. After stirring an additional 5 to 20 minutes, the product poured from the flask. The resulting product was a clear, water-white viscous liquid.

### EXAMPLE 4

878.4 g of Actflow UT-1001 (Soken), was mixed with 1.53 g of Dabco T-12 (Air Products and Chemicals), and heated to 93 C. 124 g of Desmodur I (Bayer) was charged to a 3 L round-bottomed flask, and the polyol mixture added over 68 minutes. During this time, the temperature increased from 20 to 40 C. The content of the flask were heated in steps to 85 C over 3 hrs and 15 minutes, then 18.7 g of 2-hydroxy ethyl acrylate (Dow) mixed with 0.21 g para-methoxy phenol (Aldrich) were added. The flask contents were held at 85-89 C for an additional 2½ hours, an additional 0.20 g of para-methoxy phenol was added, with stirring. After stirring an additional 5 to 20 minutes, the product poured from the flask. The resulting product was a clear, water-white viscous liquid.

### EXAMPLE 5

704 g of Actflow UT-1001 (Soken), was mixed with 0.94 g of Dabco T-12 (Air Products and Chemicals), and heated to 93 C. 130.8 Mondur TD 80, Grade B (Bayer), toluene diisocyanate, was charged to a 3 L round-bottomed flask, and the polyol mixture was added over 60 minutes. The temperature increased from 20 to 65 C. The contents of the flask were held at 67-72 C for 2 hrs and 10 minutes, then 74.5 g of 2-hydroxy ethyl acrylate (Dow), mixed with 0.20 g para-methoxy phenol (Aldrich) was added over about 10 minutes. The flask contents were heated from 70 to 88 C. After an additional 105 minutes, another 5.6 g of 2-hydroxy ethyl acrylate were added. After heating an additional 30 minutes, the flask was covered and allowed to cool to room temperature. After 13 hours, it was re-heated to 97 C, then held at 85 to 93 C for 2 hours, after which an additional 06 g of 2-hydroxy ethyl acrylate was added. After 90 more minutes, 0.18 g of para-methoxy phenol was added, with stirring. After stirring an additional 5 to 20 minutes, the product poured from the flask. The resulting product was a clear, light colored viscous liquid.

### EXAMPLE 6

55.7 g of 2-hydroxy ethyl acrylate (Dow) was mixed with 0.18 g para-methoxy phenol (Aldrich) at room temperature. 109.6 g Mondur TD 80, Grade B (Bayer) was charged to a 3 L round-bottomed flask, then 0.27 g 2,6-di-tert-4-methylphenol (PMC Specialties Group) was added. The 2-hydroxy ethyl acrylate mixture was added to the flask contents over about 80 minutes, at a temperature of 22 to 30 C. The flask contents were heated to 71 C, then the temperature maintained at 61 to 65 C for another 80 minutes. Then 0.88 g of Dabco T-12 (Air Products and Chemicals) was added to the flask, followed by 721 g of Actflow UT-1001 (heated to 60 C), which was added over 2 hours and 20 minutes, during which the temperature ranged from 62 to 75 C. After al of the polyol was added, the temperature was held at 86-88 C over 3 hours, then 0.17 g of para-methoxy phenol was added, with stirring. After stirring an additional 5 to 20 minutes, the product poured from the flask. The resulting product was a clear, light colored viscous liquid.

### EXAMPLE 7

898 g of Actflow UT-1001 (Soken), was mixed with 1.05 g of Dabco T-12 (Air Products and Chemicals), and heated to 93 C. 109.3 g Mondur TD 80, Grade B (Bayer) was charged to a 3 L round-bottomed flask, and the polyol mixture was added over 90 minutes. The temperature increased from 22 to 40 C during the polyol addition. Over the next 3 hours and 45 minutes, the temperature was increased n steps to 87-93 C. Then 31.3 g of 2-hydroxy ethyl acrylate (Dow) and 0.20 g para-methoxy phenol (Aldrich) were added. The flask contents were held at 97-93 C for 45 minutes, then 12.6 g of Bisomer PPA6 (polypropylene glycol monoacrylate, contains an average of six propylene glycol repeat units per molecule, available from Laporte Specialty Chemicals) was added. After 40 minutes at 87-88 C, the flask was covered and allowed to cool to room temperature. After 14 hours, it was re-heated to 60 C for 20 minutes, and an additional 0.21 g of para-methoxy phenol was added, with stirring. After stirring an additional 5 to 20 minutes, the product poured from the flask. The resulting product was a clear, light colored viscous liquid.

### EXAMPLE 8

472.8 g of Actflow UMB-2005 (Soken), an acrylic polyol based on butyl acrylate, 155 g of OTA-480 (Propoxylated Glycerol Triacrylate, Surface Specialties UCB), 0.23 g of 6-di-tert-4-methylphenol (PMC Specialties Group), and 1.16 g of Dabco T-12 (Air Products and Chemicals), were mixed and heated to 90 C. 116.7 g of Desmodur I (Bayer) was charged to a 3 L round-bottomed flask, and the polyol/monomer mixture added over 68 minutes. Approximately 1 hour into the add, and additional 111.3 g of OTA 480 was added to the flask. During this time, the temperature increased from 17 to 41 C. The content of the flask were heated in steps to 80 C over 2 hrs and 25 minutes, then 16.6 g of 2-hydroxy ethyl acrylate (Dow) mixed with 0.18 g para-methoxy phenol (Aldrich) were added. The flask contents were held at 81-87 C for an additional 2 hours, then 0.20 g of para-methoxy phenol was added, with stirring. After stirring an additional 5 to 20 minutes, the product poured from the flask. The resulting product was a clear, light colored viscous liquid.

### EXAMPLE 9

442.9 g of Actflow UT-1001 (Soken), was mixed with 1.03 g of Dabco T-12 (Air Products and Chemicals), and heated to 93 C. 83.5 g of Desmodur I (Bayer) was charged to a 3 L round-bottomed flask, and the polyol mixture added over 1 hour 40 minutes, with stirring. During this time, the temperature increased from 22 to 41 C. The content of the flask were heated in steps to 67 C over 69 minutes, then 80.1 g of Acryflow P-60, an acrylic polyol (Lyondell Chemical Co.), heated to 93 C, was added over 20 minutes. The contents of the flask were heated in steps to 92 C. After 95 minutes at 80-92 C, 0.12 g of para-methoxy phenol (Aldrich) and 18.6 g of 2-hydroxy ethyl acrylate (Dow) were added. After 2 hours and 10 minutes at 88 to 90 C, an additional 0.12 g of para-methoxy phenol was added, with stirring. After stirring an additional 5 to 20 minutes, the product poured from the flask. The resulting product was a clear, light colored viscous liquid.

### EXAMPLE 10

1502.2 g of Actflow UT-1001 (Soken), was mixed with 3.03 g of Dabco T-12 (Air Products and Chemicals), and heated to 93 C. 280 g of Desmodur I (Bayer) was charged to a 3 L round-bottomed flask, and the polyol mixture added over 70 minutes, with stirring. During this time, the temperature increased from 22 to 63 C. The contents of the flask were heated in steps to 80 C, after 72 minutes, 266.7 g of Acryflow P-60, heated to 93 C, was added over 18 minutes. The contents of the flask were heated to 87 C. After 2 hours and 30 minutes at 80-87 C, 0.42 g of para-methoxy phenol (Aldrich) and 55.1 g of 2-hydroxy ethyl acrylate (Dow) were added. After 90 minutes at 86-89 C, the flask was covered and allowed to cool to room temperature. After 13 hours, it was re-heated to 87 C, then held at 86 to 89 C for 90 minutes, after which an additional 9.4 g of 2-hydroxy ethyl acrylate was added. After 90 more minutes, 0.42 g of para-methoxy phenol was added, with stirring. After stirring an additional 5 to 20 minutes, the product poured from the flask. The resulting product was a clear, light colored viscous liquid.

### EXAMPLE 11

961.7 g of Actflow UT-1001 (Soken), was mixed with 2.03 g of Dabco T-12 (Air Products and Chemicals), and heated to 93 C. 179.2 g of Desmodur I (Bayer) was charged to a 3 L round-bottomed flask, and the polyol mixture added over 85 minutes, with stirring. During this time, the temperature increased from 22 to 61 C. The contents of the flask were heated in steps to 80 C, after 71 minutes, 170.7 g of Acryflow P-60, heated to 93 C, was added over 17 minutes. The contents of the flask were heated to 87 C. After 2 hours and 45 minutes at 80-87 C, 0.27 g of para-methoxy phenol (Aldrich) and 42.4 g of 2-hydroxy ethyl acrylate (Dow) were added. After 110 minutes at 86-81 C, 0.29 g of para-methoxy phenol was added, with stirring. After stirring an additional 5 to 20 minutes, the product poured from the flask. The resulting product was a clear, light colored viscous liquid.

### EXAMPLE 12

626.1 g of Actflow UT-1001 (Soken), was mixed with 1.29 g of Dabco T-12 (Air Products and Chemicals), and heated to 93 C. 105.0 g of Desmodur I (Bayer) was charged to a 3 L round-bottomed flask, and the polyol mixture added over 52 minutes, with stirring. During this time, the temperature increased from 22 to 69 C. The contents of the flask were heated in steps to 81 C, after 68 minutes, 111.1 g of Acryflow P-60, heated to 93 C, was added over 24 minutes. The contents of the flask were heated to 89 C. After 3 hours and 8 minutes at 85-91 C, 0.18 g of para-methoxy phenol (Aldrich) and 15.4 g of 2-hydroxy ethyl acrylate (Dow) were added. After 135 minutes at 87-93 C, 0.17 g of para-methoxy phenol was added, with stirring. After stirring an additional 5 to 20 minutes, the product poured from the flask. The resulting product was a clear, light colored viscous liquid.

### EXAMPLE 13

450.8 g of Actflow UT-1001 (Soken), was mixed with 1.07 g of Dabco T-12 (Air Products and Chemicals), and heated to 93 C. 93.3 g of Desmodur I (Bayer) was charged to a 3 L round-bottomed flask, and the polyol mixture added over 17 minutes, with stirring. During this time, the temperature increased from 23 to 66 C. The contents of the flask were heated in steps to 83 C, after 90 minutes, 133.4 g of Acryflow P-60, heated to 93 C, was added over 20 minutes. The contents of the flask were heated to 89 C. After 2 hours and 59 minutes at 84-98 C, 0.14 g of para-methoxy phenol (Aldrich) and 22.5 g of 2-hydroxy ethyl acrylate (Dow) were added. After 130 minutes at 86-93 C, 0.14 g of para-methoxy phenol was added, with stirring. After stirring an additional 5 to 20 minutes, the product poured from the flask. The resulting product was a clear, light colored viscous liquid.

### EXAMPLE 14

500.9 g of Actflow UT-1001 (Soken), was mixed with 1.25 g of Dabco T-12 (Air Products and Chemicals), and heated to 93 C. 140.0 g of Desmodur I (Bayer) was charged to a 3 L round-bottomed flask, and the polyol mixture added over 71 minutes, with stirring. During this time, the temperature increased from 23 to 60 C. The contents of the flask were heated in steps to 80 C, after 86 minutes, 89.9 g of Acryflow P-60, heated to 93 C, was added over 10 minutes. The contents of the flask were heated to 88 C. After 2 hours and 45 minutes at 80-88 C, 0.16 g of para-methoxy phenol (Aldrich) was added, then 64.5 g of 2-hydroxy ethyl acrylate (Dow) was added over 9 minutes time. After 115 minutes at 87-92 C, 0.16 g of para-methoxy phenol was added, with stirring. After stirring an additional 5 to 20 minutes, the product poured from the flask. After stirring an additional 5 to 20 minutes, the product poured from the flask. The resulting product was a clear, light colored viscous liquid.

### EXAMPLE 15

413.4 g of Actflow UT-1001 (Soken), was mixed with 373.4 g of Acryflow P-60, 242.7 g ethyl acetate (Fisher) and 1.82 g of Dabco T-12 (Air Products and Chemicals), and heated to 60 C. 116.7 g of Desmodur I (Bayer) was charged to 3 L a round-bottomed flask, then 177.1 g of ethyl acetate was added. The polyol mixture added over 1 hour and 35 minutes, with stirring. During this time, the temperature increased from 21 to 26 C. The contents of the flask were heated in steps to 88 C as the flask contents were stirred for 6½ hours. The mixture was cooled to room temperature. After 15 hours, the mixture was heated to 67 C, and 0.28 g of para-methoxy phenol (Aldrich) and 61.5 g of Bisomer PPA 6 (Laporte) was added. After 3 hours at 77-84 C, 10.4 g more of the PPA 6 was added, then another 11.14 g of PPA 6 was added after 3 more hours. One hour after that, 120 g ethyl acetate was added, then 0.30 g para-methoxy phenol, then 237.2 g of OTA-480 (Propoxylated Glycerol Triacrylate, Surface Specialties UCB). While stirring, the mixture was cooled to room temperature. The product is a clear, light yellow viscous liquid. 1031 g of this product was stripped under vacuum for 3 hours to remove the solvent. The resulting product was very viscous, but GPC analysis indicated that it had essentially the same molecular weight as the unstripped product.

All of the above urethane (meth)acrylate with an acrylic backbone's contain essentially no solvent.

Feed Mole Ratios and Stoichiometry and Impurity Levels

As demonstrated by the above synthesis examples, the urethane (meth)acrylate with acrylic backbones can unexpectedly be produced in essentially solvent-free form, without gellation, at moderate to high reaction temperatures. Toluene diisocyanate as well as isophorone diisocyanate can be used in this process, which is again unexpected considering the assertion in the prior art that IPDI only can be used if gelling is to be avoided when making urethane (meth)acrylates from similar acrylic polymer polyols. Indeed, L. W. Arndt, L. J. Junker, S. P. Patel, D. B. Pourreau, and W. Wang in “One and Two-Component UV-Curable Acrylic Urethane Coatings for Weatherable Applications”, presented at the 80^{th} Annual Meeting for the Federation of Societies for Coatings Technology, October 30 through Nov. 1, 2002. 2342-V1-1202, state that it is not possible to make urethane acrylates with TDI (toluene diisocyanate) or HDI (hexamethylene diisocyanate) from acrylic polyols, as insoluble gels result, even in the presence of solvent. Thus, the present invention's successful synthesis of aromatic urethane acrylate with an acrylic backbone made using TDI as the diisocyanate as described in examples 5, 6 and 7, is unexpected.

Arndt, et. al. discusses the challenges in making “acrylated urethane acrylates” and note that traditional solvent-free synthesis
“typically results in highly crosslinked, viscous or even gelled, products that are not suitable for coatings applications.”

They describe how “low viscosity” acrylated urethane acrylates were made in solvent (27 to 18% butyl acetate) by reacting acrylic polyol with a large excess of IPDI (isophorone diisocyanate), then capping the unreacted isocyanate with an excess of hydroxy ethyl acrylate (HEA). Arndt, et. al. further state that the minimum ratio of molar equivalents of diisocyanate to molar equivalents of hydroxy in the acrylic polyol should be at least 2.2. To illustrate the unexpected nature of the present invention, Table 1 presents the number of equivalents of each reagent, and the ratio of isocyanate to acrylic polymer polyol hydroxy groups for the preceding synthesis examples. The molar equivalent ratio of diisocyanate to acrylic polyol hydroxy is significantly below the 2.2 minimum value cited in Arndt, et. al.

The “acrylated urethane acrylates” of Arndt, et. al. can further be distinguished from the urethane (meth)acrylate with acrylic backbones of the present invention by examining the ratio of hydroxy groups in the acrylic polyol to hydroxy groups in the hydroxy alkyl acrylate. As shown in Table 1, this ratio ranges from 1.0 to over 5 for the present invention, while this ratio is substantially below 1.0 in Arndt, et. al. This ratio (n) corresponds to the “extension” or degree of polymerization of a urethane acrylate oligomer, as shown below:
Hydroxyacrylate−(diisocyanate−acrylic polyol)ₙ−diisocyanate−hydroxyacrylate

TABLE 1

| | | | | | Acrylic-OH/ |
|---|---|---|---|---|---|
| Synthesis | Diisocyanate | Acrylic Polyol | Hydroxyacrylate | NCO/ | Hydroxyacrylate- |
| Example | (equivalents) | (equivalents) | (moles) | acrylic OH¹ | OH² |
| 2, 5, 14 | 4 | 2 | 2 | 2.0 | 1.0 |
| 6 | 5 | 3 | 2 | 1.7 | 1.5 |
| 3, 7, 8, 9, | 8 | 6 | 2 | 1.3 | 3.0 |
| 10, 11, 13 | | | | | |
| 12 | 12 | 10 | 2 | 1.2 | 5.0 |
| 1, 4, 15 | 12.5 | 10.5 | 2 | 1.2 | 5.25 |
| Prior art | 2.5 | 1.1 | 2 | 2.27 | 0.55 |
| (Arndt, et. | | | | | |
| al.³ UV120) | | | | | |

¹Mole ratio for formation of isocyanate functional pre-polymers, before addition of hydroxy acrylate.
²Ratio of hydroxy equivalents in acrylic polyol to hydroxy equivalents in hydroxy alkyl(meth)acrylate.
³“One and Two-Component UV-Curable Acrylic Urethane Coatings for Weatherable Applications” presented at the 80th Annual Meeting of Federation of Societies for Coatings Technology, Oct. 30-Nov. 1, 2002, 2342-V1-1202.

A significant distinction between the prior art, as reported in Arndt, et. al., and the oligomers of the present invention are the substantially higher impurities levels in the prior art oligomers, as shown in Table 2. The prior art acrylated oligomers contain a significant amount of free HEA and a large amount of “IPDI diacrylate”. In contrast, the urethane (meth)acrylate with an acrylic backbone of the present invention contain little IPDI diacrylate or TDI diacrylate and very little residual HEA. The oligomers of the present invention are unexpectedly low enough in viscosity to allow easy formulation into inks without addition of solvent.

HEA is toxic and can be absorbed through the skin, thus is undesirable due to regulatory and workplace exposure considerations. Additionally, as a low molecular weight diluent, low levels in an ink formulation can contribute to ink misting. Residual amounts of other hydroxy (meth)acrylates, such as 2-hydroxypropyl acrylate are also undesirable for similar reasons.

An object of this invention is to produce urethane (meth)acrylate with acrylic backbones with low unreacted residual hydroxy(meth)acrylate content, preferably less than 1 percent by weight.

Diisocyanate diacrylates such as IPDI and TDI diacrylate are acrylated monomers which decrease ink or coating flexibility after cure. At high levels (over about 5 to 10 percent by weight) these diisocyanate diacrylates also impact rheology of ink formulations due to increased hydrogen bonding and poor compatibility with less polar components of the ink.

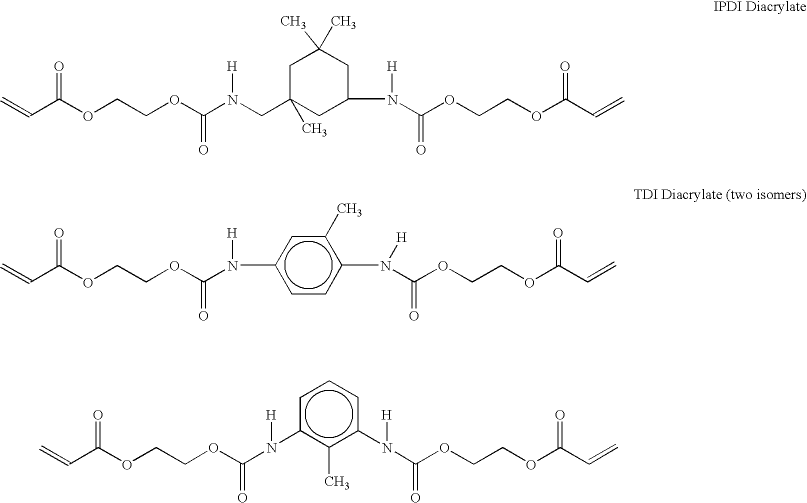

The structures shown are for the IPDI and TDI adducts with hydroxyethyl acrylate. If hydroxyalkyl (meth)acrylates other than hydroxyethyl acrylate are used to synthesize the urethane (meth)acrylate with acrylic backbones, other diisocyanate diacrylate monomers will be formed as impurities. These impurities will be similar in structure to, and have similar negative effects on ink properties, as the diisocyanate diacrylate monomers based on hydroxyethyl acrylate.

Another object of this invention is to produce urethane (meth)acrylate with acrylic backbones with low diisocyanate diacrylate content, preferably less than 5% by weight.

TABLE 2

| Synthesis | % IPDI (or TDI) | | viscosity |
|---|---|---|---|
| Example | diacrylate | % residual HEA | (cps @ 60 C.) |
| 1 | 0.6 | 0.5 | 2,071 |
| 2 | 3.4 | <0.01 | 8,233 |
| 3 | 0.13 | <0.005 | 11,050 |
| 4 | 0.015 | <0.01 | 14,280 |
| 5 | 2.8 (TDI) | <0.01 | 9,750 |
| 6 | 2.2 (TDI) | <0.005 | 10,720 |
| 7 | 0.41 (TDI) | <0.005 | 13,230 |
| 8 | none detected | 0.32 | 11,230 |
| 9 | 0.11 | <0.005 | 21,950 |
| 10 | 0.12 | <0.0054 | 17,550 |
| 11 | 0.10 | <0.010 | 20,000 |
| 12 | 0.03 | <0.010 | 39,000 |
| 13 | 0.14 | <0.010 | 21,290 |
| 14 | 4.3 | 0.04 | 11,330 |
| Prior art | 31 | 1.2 | 18% solvent |
| (Arndt, et. al | | | |
| UV90) | | | |
| Prior art | 18 | 1.2 | 27% solvent |
| (Arndt, et. al | | | |
| UV120) | | | |

All of the urethane (meth)acrylate with an acrylic backbone of the present invention contain essentially no solvent, and contain significantly less diisocyanate diacrylate and much less free HEA than reported for the compositions reported in Arndt, et. al.

An important and unexpected benefit of the present invention is the demonstrated ability to manufacture the urethane (meth)acrylates with an acrylic backbone via a “one pot” synthesis in the absence of solvent, which, if present, must be removed to produce a substantially solvent free product. Solvent removal is generally accomplished by vacuum stripping or distillation, rotary evaporation, wiped film distillation, or other energy intensive processes. The conditions under which the solvent is removed must be carefully controlled to prevent the acrylated oligomer from gelling, complicating the process.

The synthetic method of the present invention, which does not require solvent to produce a usable solvent free liquid product, is unexpected based on Arndt, et. al. and JP2001210926. In the Japanese patent, acrylic polyols are converted to urethane acrylates with acrylic backbones in the presence of solvent (toluene), excess hydroxy ethyl acrylate (HEA), and hexamethylene diisocyanate (HDI). Following the reaction, the solvent, excess HEA and excess HDI are removed by evaporation at 80 degrees C. under reduced pressure. In contrast, the synthetic process of the present invention requires no solvent, and no excess reagents which must be removed in a subsequent processing step. Hexamethylene diisocyanate is preferred when a stripping process such as is disclosed in JP2001210926 is used because its volatility allows it to be removed easily under moderate stripping conditions. Other diisocyanates known to the art are much less volatile and severe conditions are required to strip off unreacted diisocyanate.

Also, the oligomers of the present invention are made with much more isocyanate, relative to acrylic polyol, than is specified by JP2001210926. The composition of the oligomers of the present invention is unexpected considering the specification in JP2001210926 that only 100 to 120 moles isocyanate (preferably 105 to 115) be used to 100 moles hydroxy in the acrylic polyol, and 100 moles hydroxy (meth)acrylate. Thus, the composition of the oligomers disclosed in JP2001210926 differs greatly from the composition of the urethane (meth)acrylate with an acrylic backbone of the present invention as sown in the Table 3.

TABLE 3

| | | | | Acrylic-OH/ |
|---|---|---|---|---|
| | | | Hydroxy- | Hydroxy- |
| Synthesis | Isocyanate | Acrylic Polyol | acrylate | acrylate- |
| Example | (moles) | (equivalents)⁴ | (moles) | OH⁵ |
| 2, 5, 14 | 4 | 2 | 2 | |
| | 200 | 100 | 100 | 1.0 |
| 6 | 5 | 3 | 2 | |
| | 167 | 100 | 67 | 1.5 |
| 3, 7, 8, 9, | 8 | 6 | 2 | |
| 10, 11, 13 | 133 | 100 | 33 | 3.0 |
| 12 | 12 | 10 | 2 | |
| | 120 | 100 | 20 | 5.0 |
| 1, 4, 15 | 12.5 | 10.5 | 2 | |
| | 119 | 100 | 19 | 5.3 |
| JP2001210926 | 100-120 | 100 | 105-115 | 0.87-0.95 |
| (specification) | | | | |

⁴Equivalents of acrylic polyol are normalized to 100 for facile comparison of synthesis examples of present invention and ratios specified by JP2001210926.
⁵Ratio of hydroxy equivalents in acrylic polyol to hydroxy equivalents in hydroxy alkyl(meth)acrylate.

A second unexpected difference between the present invention oligomers and those disclosed in JP2001210926 is the relative amount of acrylic polyol and diisocyanate used in the synthesis. In all the relative amount of acrylic polyol in the present invention exceeds that of JP2001210926 by a factor of 2 or more. Table 4 summarizes these data for the synthesis examples from JP2001210926 and several examples of the present invention:

TABLE 4

| | | | | gram ratio |
|---|---|---|---|---|
| | g acrylic | | g | (acrylic polyol |
| Example | polyol | diisocyanate | diisocyanate | to isocyanate) |
| JP2001210926 | 100 | HDI | 49 | 2.04 |
| Example 1 | | | | |
| JP2001210926 | 18.5 | HDI | 49 | 0.38 |
| Example 2 | | | | |
| Example 2 | 514 | IPDI | 124 | 4.14 |
| Example 3 | 541 | IPDI | 84 | 6.44 |
| Example 4 | 878.4 | IPDI | 158.5 | 5.54 |
| Example 5 | 704 | TDI | 130.8 | 5.38 |

### EXAMPLE 16

### Vehicle for Lithographic Ink

A printing ink vehicle was made from an oligomer prepared as in Example 4, then the properties of the new vehicle were compared to those of a prior art polyester acrylate vehicle commonly used in formulating lithographic ink formulations. The two vehicles were prepared and tested in parallel.

Viscosities of the ink vehicles were measured using a Brookfield Model II+viscometer with a small cell adapter. Oligomer tack was measured using a Thwing-Albert Electronic Inkometer, model 106, at 400 RPM, 90° F. for three minutes.

All parts and percentages of composition are by weight unless stated otherwise.

TABLE 5
Lithographic Ink Vehicle Compositions and Properties

| | Comparative | |
|---|---|---|
| | Example | Example 16 |
| Ebecryl 870 | 100 | 75 |
| DPHPA | 0 | 10 |
| Oligomer prepared as in Example 4 | 0 | 12 |
| Viscosity, cP @ 25 degrees C. | 45,200 | 66,300 |
| Vehicle Tack, | 12.8 | 18.5 |
| gram-meter @ 400 RPM, 25 degrees C. | | |

Products used to formulate the ink vehicle of the present invention and the comparative example include Ebecryl 870 (Surface Specialties, UCB) a hexafunctional polyester acrylate designed for use in lithographic inks and DPHPA (Surface Specialties, UCB), acrylated dipentaerythritol.

### EXAMPLE 17

### Lithographic Ink

In order to compare the performance of lithographic inks made with the invention, a series of magenta inks were prepared. Ink preparation was in two stages: in the initial stage, pigment dispersions containing 30 percent of the conventional pigment Irgalite Rubine L4BD were made in a 60/10 blend of the lithographic ink vehicle prepared as in Example 16 and propoxylated glycerol triacrylate. During the preparation of these dispersions the ease of adding and mixing the pigment into the ink vehicle and monomer and the appearance of the millbase (prior to milling) was evaluated as were other properties after several passes through the 3 roll mill.

The ink formulae were completed in the second stage with the addition of additional ink vehicle prepared as in Example 16, additional propoxylated glycerol triacrylate, magnesium silicate, polyethylene wax and photoinitiators to the pigment dispersions. Typical lithographic ink properties such as tack, misting, adhesion and printability were measured in the conventional manner, as known to the art. Ink tack was measured with a Thwing Albert electronic inkometer at 1200 RPM, 90° F. and 3 minutes (ASTM D 4361). Adhesion onto various plastic substrates was determined by tape test (ASTM 3359) with 3M 610 tape.

As shown in Table 5 (Example 16), the properties of the ink vehicle containing the present invention are very similar the properties of the comparative ink vehicle. Despite these similarities, lithographic inks made with an ink vehicle containing the present invention have significantly improved performance particularly for ink misting, adhesion and printability, as shown in Table 6. These results are surprising and totally unexpected given the similarity of the ink vehicle properties.

TABLE 6
Lithographic Ink Properties

| | | Example 17: |
|---|---|---|
| | Comparative Example: | Ink with Example 16 |
| | Ink with Ebecryl 870 | vehicle |
| Ink Tack, | 13.2 | 17.8 |
| g-m @ 1200 RPM | | |
| ¹Ink Misting, ΔE | 12.9 | 1.1 |
| ²Adhesion to plastics | 2-3 | 4-5 |
| ³Printability | 3 | 5 |

¹Misting: Total color difference is used as an indication of the severity of ink misting or flying. A piece of white substrate is placed beneath the bottom roller of the inkometer for the duration of the tack measurement testing. Following the test, the Delta E or total color difference, is calculated by numerically comparing the color of the exposed substrate and a piece of unexposed substrate. A higher Delta E or color difference indicates more misting.
²Adhesion: 5 = excellent (100% on polystyrene, vinyl and polycarbonate); 4 = good (90-95% on polystyrene, vinyl and polycarbonate); 3 = moderate (>85% on polystyrene, vinyl and polycarbonate); 2 = fair (>65% on polystyrene, vinyl and polycarbonate); 1 = poor (<65% on polystyrene, vinyl and polycarbonate)
³Printability: Make-ready, achievable color density and print contrast and press clean up. 5 = excellent; 4 = good. 3 = moderate; 2 = fair and 1 = poor

As shown in Table 6, the ink made with the polyester acrylate/acrylic urethane (meth) acrylate vehicle of Example 16 exhibits better performance. Ink tack is increased and ink misting is significantly reduced. Adhesion to a variety of plastics including various types polystyrene, vinyl and polycarbonate is also improved. The ink made with the Example 16 vehicle also shows improved printability with good color density, print contrast and overall press performance.

### EXAMPLE 18

### Vehicle for Laminating Ink

Conventional ink vehicles for lithographic laminating inks typically contain acrylated polyesters, specialty polyesters (acid modified or chlorinated) and an acrylated monomer. The amount of acrylated polyester in the vehicle ranges from 20-80 percent and the amount of specialty polyester ranges from 20-50 percent. Acrylated monomer content is between 10 and 25 percent.

To evaluate laminating capabilities two ink vehicles were prepared. Vehicle compositions are listed in Table 7:

TABLE 7
Laminating Ink Vehicle Compositions

| | Comparative | |
|---|---|---|
| | Example | Example 18 |
| Ebecryl 870 | 70 | 65 |
| Ebecryl 436 | 30 | 0 |
| DPHPA | 0 | 10 |
| Oligomer prepared as in | 0 | 25 |
| Example 4 | | |

Products used to formulate the ink vehicle of the present invention and the comparative example include Ebecryl 870 (Surface Specialties, UCB) a hexafunctional polyester acrylate designed for use in lithographic inks, Ebecryl 436 (Surface Specialties, UCB), a chlorinated polyester resin with a high acid value (about 20 mg KOH/g) diluted in 40% TMPTA (trimethylolpropane triacrylate), and DPHPA (Surface Specialties, UCB), acrylated dipentaerythritol.

### EXAMPLE 19

### Laminating Ink

Using the procedures described earlier in Example 17, the vehicles were converted to inks. Ink testing included adhesion to non-porous substrates, printability and a benchtop laminating pull test. The results are given in Table 8. Use of the oligomer of the present invention provides inks with better adhesion, improved bond strength and printability.

TABLE 8
Laminating Ink Properties

| | | Example 19: |
|---|---|---|
| | Comparative Example: | Ink with Example 18 |
| | Ink with Ebecryl 436 | Vehicle |
| ¹Adhesion to plastics | 2 | 5 |
| ²Printability | 2 | 5 |
| ³Laminating Pull Test | 2 | 5 |

¹Adhesion: 5 = excellent (100% on polystyrene, vinyl and polycarbonate); 4 = good (90-95% on polystyrene, vinyl and polycarbonate); 3 = moderate (>85% on polystyrene, vinyl and polycarbonate); 2 = fair (>65% on polystyrene, vinyl and polycarbonate); 1 = poor (<65% on polystyrene, vinyl and polycarbonate)
²Printability: Make-ready, achievable color density and print contrast and press clean up. 5 = excellent; 4 = good. 3 = moderate; 2 = fair and 1 = poor
³Laminating pull test: Printed non-porous stock is laminated using GBC Laminating Pro laminator and 7 mil thermal laminating pouch at 302° F. and 72 seconds dwell. After cooling the top laminate layer is pulled away and percentage of ink removed from the substrate is rated. 5 = excellent (0% ink removed); 4 = good (5-10% of ink removed); 3 = fair (30-50% ink removed); 2 = poor (>50% ink removed)

Hence, it is clear from the preceding examples that a lithographic ink and a laminating made with an ink vehicle containing a urethane (meth)acrylate with an acrylic backbone provides improved performance over similar inks made with conventional acrylated ink vehicles.

1. An acrylic urethane (meth)acrylate oligomer, which comprises an acrylic urethane backbone comprising a reaction product of an acrylic polyol and a diisocyanate, which backbone is capped with a hydroxy(meth)acrylate, the acrylic urethane (meth)acrylate oligomer comprises residues in the following order:
hydroxy(meth)acrylate−(diisocyanate−acrylic polyol)ₙ−diisocyanate−hydroxy(meth)acrylate (“structure 1”)
wheren is 1 to 10.

2. The oligomer according to claim 1, wherein the acrylic polyol comprises a reaction product of a polymer or copolymer of acrylic monomers with a hydroxy containing chain transfer agent, a hydroxy containing initiator, and mixtures thereof.

3. The oligomer according to claim 2, wherein the acrylic monomers comprise ethyl acrylate, ethyl hexyl acrylate, or butyl acrylate.

4. The oligomer according to claim 2, wherein the hydroxy containing chain transfer agent or hydroxy containing initiator comprises a diol.

5. The oligomer according to claim 1, wherein the acrylic polyol has a number average molecular weight as measured by measured by gel permeation chromatography of 1000 to 5000.

6. The oligomer according to claim 1, wherein the diisocyanate comprises 3-isocyanatomethyl-3,5,5-trimethylcyclohexylisocyanate (isophorone diisocyanate or IPDI), 2,4-toluene diisocyanate and 2,6-toluene diisocyanate as well as mixtures of these diisocyanates (TDI); 4,4′-diphenylmethane diisocyanate (MDI), 2,4′-diphenylmethane diisocyanate, 4,4′-dicyclohexyldiisocyanate or reduced MDI (also known as dicyclohexanemethane diisocyanate), meta- and para-tetramethyl xylene diisocyanate (TXMDI), hydrogenated meta-tetramethyl xylene diisocyanate [1,3-bis(isocyanatemethyl)cyclohexane], hexamethylene diisocyanate (HDI), norbornane diisocyanate (NBDI), 2,2,4- and 2,4,4-trimethylenehexamethylene diisocyanate (TMDI), 1,5-naphthylene diisocyanate (NDI), dianisidine diisocyanate, di(2-isocyanatoethyl)bicyclo[2.2.1]-hept-5-ene-2,3-dicarboxylate, 2,4-bromotoluene diisocyanate, 2,6-bromotoluene diisocyanate, 2,4-/2,6-bromotoluene diisocyanate, 4-bromo-meta-phenylene diisocyanate, 4,6-dibromo-meta-phenylene diisocyanate and mixtures thereof.

7. The oligomer according to claim 1, wherein the diisocyanate comprises 3-isocyanatomethyl-3,5,5-trimethylcyclohexylisocyanate (isophorone diisocyanate or IPDI) or 2,4-toluene diisocyanate and 2,6-toluene diisocyanate as well as mixtures of these diisocyanates (TDI).

8. The oligomer according to claim 1, wherein the hydroxy(meth)acrylate comprises 2-hydroxyethyl acrylate (HEA), 2-hydroxyethylmethacrylate (HEMA); 2-hydroxypropyl meth)acrylate, 3-hydroxypropyl (meth)acrylate, 2-hydroxybutyl (meth)acrylate; 4-hydroxybutyl (meth)acrylate, 3-hydroxypentyl (meth)acrylate, 6-hydroxynonyl (meth)acrylate, 2-hydroxy and 5-hydroxypentyl (meth)acrylate; 7-hydroxyheptyl (meth)acrylate and 5-hydroxydecyl (meth)acrylate, diethylene glycol mono(meth)acrylate, polyethylene glycol mono(meth)acrylate, propylene glycol mono(meth)acrylate, polypropylene glycol mono(meth)acrylate, (meth)acrylates combining ethoxylation and propoxylation, caprolactone-2-hydroxyethyl acrylate adducts and mixtures thereof.

9. The oligomer according to claim 1, wherein the hydroxy(meth)acrylate comprises 2-hydroxyethyl acrylate (HEA), 2-hydroxyethylmethacrylate (HEMA), polypropylene glycol monoacrylate, polyethylene glycol monoacrylate, caprolactone-2-hydroxyethyl acrylate adducts, and mixtures thereof.

10. The oligomer according to claim 1, wherein the acrylic backbone further comprises styrene, allylic derivatives of styrene, or vinylic derivatives of styrene.

11. The oligomer according to claim 1, which comprises residues in the following order:
hydroxy(meth)acrylate−(diisocyanate−acrylic polyol)ₙ−diisocyanate−hydroxy(meth)acrylate
where n is 2 to 6.

12. The oligomer according to claim 1, which has an unreacted hydroxy(meth)acrylate content of less than 1% by weight.

13. The oligomer according to claim 1, which has an unreacted hydroxyethyl acrylate content of less than 1% by weight.

14. The oligomer according to claim 1, which has a diisocyanate diacrylate content of less than 5% by weight.

15. A one pot process for making the oligomer according to claim 1, which comprises reacting the acrylic polymer polyol, diisocyanate, and hydroxy(meth)acrylate to obtain the oligomer according to claim 1.

16. The one pot process according to claim 15, wherein the acrylic polymer polyol and diisocyanate are reacted to obtain a reaction product, which reaction product is then reacted with the hydroxy(meth)acrylate.

17. The one pot process according to claim 15, wherein the diisocyanate and hydroxy(meth)acrylate are reacted to obtain a reaction product, which reaction product is then reacted with the acrylic polymer polyol.

18. The one pot process according to claim 15, which is conducted without a solvent.

19. The one pot process according to claim 15, which is performed without stripping of solvent, unreacted hydroxy(meth)acrylate or diisocyanate.

20. An energy curable ink composition, which comprises the oligomer according to claim 1.

21. The ink composition according to claim 20, which further comprises at least one ingredient selected from the group consisting of pigments, resins, diluents, waxes, greases, plasticizers, stabilizers, photoinitiators, curing agents, thickeners, fillers, inhibitors, wetting agents, flow agents, leveling agents, and adhesion promoters.

22. The ink composition according to claim 20, which is energy curable with actinic or ionizing radiation.

23. The ink composition according to claim 20, which is substantially water free and solvent free.

24. An article of manufacture, comprising a substrate having a surface coated with the energy curable ink composition according to claim 20, wherein the ink composition is a laminating ink composition.

25. An article of manufacture, comprising a substrate having a surface coated with the energy curable ink composition according to claim 20, wherein the ink composition is a lithographic ink composition.

26. An article of manufacture, comprising a substrate having a surface coated with the energy curable ink composition according to claim 20, which has been subjected to energy curing.

27. The ink composition according to claim 20, which has a color of black, cyan, magenta or yellow, a low ink misting of ΔE≦6, and a 90-100% adhesion to vinyl, polystyrene and polycarbonate.
